(19) United States
(12) Patent Application Publication
(10) Pub. No.: US 2025/0342459 A1
(43) Pub. Date: Nov. 6, 2025

(54) SYSTEMS AND TECHNIQUES FOR VALIDATING OFFLINE DATA TRANSFERS

(71) Applicant: Apple Inc., Cupertino, CA (US)

(72) Inventors: Frank Andries van den Berg, San Jose, CA (US); Raphael Hudon-Voyer, Montreal (CA); Sebastien Fontaine, Montreal (CA); Benoit L. Floc'h, Montreal (CA); Pradeepa Krishnamoorthy, L'lle-Perrot (CA); Robin Burel, Santa Clara, CA (US); Varun A. Vora, Campbell, CA (US); Vincent Pozzuoli, Montreal (CA)

(73) Assignee: Apple Inc., Cupertino, CA (US)

(21) Appl. No.: 18/896,360

(22) Filed: Sep. 25, 2024

Related U.S. Application Data
(63) Continuation of application No. 18/656,178, filed on May 6, 2024.

(51) Int. Cl. G06Q 20/36; G06Q 20/38; G06Q 20/40

(52) U.S. Cl. CPC G06Q 20/3672; G06Q 20/3829; G06Q 20/401

(57) ABSTRACT

A method may include receiving, by an application executed on a user device, sensitive data associated with one or more data exchanges. The method may include generating, by a background application executed on the user device, validation data. The method may include retrieving, by the application executed on the user device, the validation data from the background application. The method may include transmitting, by the application executed on the user device, the validation data, and the sensitive data to a first computing system. The method may include receiving, by a second computing system, the validation data from the first computing system. The method may include generating, by the second computing system, the token, digitally signed by the second computing system. The method may include transmitting, by the second computing system, the token to the first computing system. The method may include receiving the token from the first computing system.

### CROSS-REFERENCES TO RELATED APPLICATIONS

This application is a continuation of U.S. application Ser. No. 18/656,178, filed May 6, 2024, entitled “Tap To Pay Store And Forward,” hereby incorporated by reference in its entirety and for all purposes.

### BACKGROUND

The collection of sensitive data is necessary to complete transactions. As the collection of the sensitive data is performed by more user-oriented devices, security of the sensitive data and the integrity of the sensitive data poses different challenges to parties responsible for handling the sensitive data. For example, if a device is not connected to a network, processing collected sensitive data may be delayed and present opportunities for the sensitive data to be compromised by a bad actor. Thus, there is a need to improve systems and methods to handle and store sensitive data for future processing.

### BRIEF SUMMARY

A method of validating data exchanges via a token may include receiving, by an application executed on a user device, sensitive data associated with one or more data exchanges. The method may include generating, by a background application executed on the user device, validation data. The validation data may include an exchange count, a session identifier, and a device identifier. The method may include retrieving, by the application executed on the user device, the validation data from the background application. The method may include transmitting, by the application executed on the user device, the validation data, and the sensitive data to a first computing system. The method may include receiving, by a second computing system, the validation data from the first computing system, the second computing system associated with the background application. The method may include generating, by the second computing system, the token, the token digitally signed by the second computing system. The method may include transmitting, by the second computing system, the token and some or all of the validation data to the first computing system. The method may include receiving, by the background application executed on the user device, the token from the first computing system.

In some embodiments, the method may include receiving, by the application executed on the user device, a trigger indicating that the user device is offline. The method may include, in response to receiving the trigger, establishing, by the application executed on the user device, an offline processing session. In some embodiments, the application executed on the user device may retrieve the validation data from the background application in response to determining that the user device is online. In some embodiments, during the offline processing session, the application may be permitted to receive sensitive data for a predetermined time period. The sensitive data and the validation data may be encrypted using a public private key pair. The sensitive data may include transaction data. The validation data may include respective data exchange identifiers, each associated with a respective data exchange and a hash of at least a portion of the sensitive data.

A system for validating data exchanges via a response token during an offline processing session may include one or more processors, an application, a background application and a computer-readable memory including instructions that, when executed by the one or more processors, cause the system to perform operations. According to the operations, the system may receive, by the application, sensitive data associated with one or more data exchanges. The system may generate, by the background application, validation data may include an exchange count, a session identifier, a device identifier. The system may retrieve, by the application, the validation data from the background application. The system may transmit, by the application, the validation data and the sensitive data to a first computing system. The system may receive, by a second computing system, the validation data from the first computing system, the second computing system associated with the background application. The system may generate, by the second computing system, the response token, the response token digitally signed by the second computing system. The system may transmit, by the second computing system, the response token to the first computing system. The system may receive, by the background application, the response token from the first computing system.

In some embodiments, the response token may be protected using a public-private key pair. The application may enter the offline processing session in response to determining that the user device is offline. The application may retrieve the validation data from the background application in response to determining that a user device is online. During the offline processing session, the application may be permitted to receive sensitive data for a predetermined time period. The sensitive data and the validation data may be encrypted using a public private key pair. The sensitive data may include transaction data. The validation data may include respective data exchange identifiers, each associated with a respective data exchange and a hash of at least a portion of the sensitive data.

a non-transitory computer-readable medium may include instructions that, when executed by one or more processors, cause the one or more processors to perform operations. The operations may include receiving, by an application executed on a user device, sensitive data associated with one or more data exchanges. The operations may include generating, by a background application executed on the user device, validation data. The validation data may include an exchange count, a session identifier, and a device identifier. The operations may include retrieving, by the application executed on the user device, the validation data from the background application. The operations may include transmitting, by the application executed on the user device, the validation data, and the sensitive data to a first computing system. The operations may include receiving, by a second computing system, the validation data from the first computing system, the second computing system associated with the background application. The operations may include generating, by the second computing system, the token, the token digitally signed by the second computing system. The operations may include transmitting, by the second computing system, the token and some or all of the validation data to the first computing system. The operations may include receiving, by the background application executed on the user device, the token from the first computing system.

### BRIEF DESCRIPTION OF THE DRAWINGS

FIG. 1 illustrates a system and a process for validating data exchanges using a validation token, according to certain embodiments.

FIG. 2A-2E illustrate a system for validating data exchanges while not connected to a network, according to certain embodiments.

FIG. 3 illustrates a flowchart of a method for validating data exchanges, according to certain embodiments.

FIG. 4 illustrates an example architecture or environment configured to implement techniques relating to validating data exchanges, according to certain embodiments.

### DETAILED DESCRIPTION

Network communication has improved the speed and convenience of processing sensitive data. Data exchanges that used to be handled by hard copy may now be performed near instantaneously via communication through networks such as the internet. Additionally, components and functionality used in sensitive data exchanges have become more common on more devices. For example, mobile devices, tablets, and the like have recently been used in the exchange of data for small businesses. This may enable users to easily perform data exchanges with a personal device, rather than a dedicated device, designed exclusively to collect sensitive data and transmit the sensitive data to a third-party. However, certain risks may be present by having sensitive data stored or held on a personal device. To minimize those risks, sensitive data may generally be transferred and removed from the device to a third-party as the sensitive data is collected. This way, the sensitive data may not be held on the device for any longer than necessary, minimizing the risk of access and/or tampering by a bad actor.

The transfer of the sensitive data from the device to the third-party may be hindered by a loss of network connection. If the device cannot communicate with the third-party, the device cannot transfer sensitive data. In this situation, the device (or user thereof) may have two choices. First, the device may stop all data exchanges until the network connection is restored. No sensitive data may be compromised if no sensitive data is collected. This option may not be desirable, however, because a user of the device may wish to continue operations as normal, despite the network disruption. A second option may be for the device may collect and store sensitive data, in order to transmit (and process) the sensitive data once the network connection is restored.

The second option also presents some issues. One issue is the risk of exposure of sensitive data. The device may be accessed by a bad actor (e.g., the user of the device, another user, etc.) who attempts to access the sensitive data. The exposure of the sensitive data not only may harm the owner of the sensitive data, but other parties responsible for the sensitive data may also be at risk (e.g., liability, etc.). To address this issue, an application running on the device may encrypt sensitive data as it is collected by the device. The sensitive data may be encrypted using a key or other method such that the user and/or device cannot decrypt the data. Instead, a computing system associated with the application may be the only party able to provide a key to the decrypt the sensitive data. The application may then store the encrypted sensitive data until the network connection is restored and then transmit the encrypted sensitive data to a third-party.

While the encryption of the sensitive data may reduce the risk of exposure of the sensitive data, other security and/or integrity issues may be present. For example, while the device may store the encrypted data, the user of the device may modify the encrypted data somehow, creating records of data exchanges that may not have occurred and/or removing records of data exchanges that did occur. Without communication to the third party as the data exchanges are happening, the tampered records of the data exchanges may not be discovered by the any of the involved parties.

One solution to this problem may be to have an application on a user device enter an offline mode when not connected to a network. An application on the user device may receive sensitive data, encrypt the sensitive data, then transmit the encrypted sensitive data to one or more computing systems. Generally, the encrypted sensitive data may be deleted from the user device after the encrypted sensitive data is transmitted. The user device may detect that a network connection is not available, no longer connected, etc. In response, the application may enter into an offline session. While in the offline session, the application may continue to receive and encrypted sensitive data. Because the user device is not connected to a network, however, the encrypted sensitive data may not be transmitted to the computing systems of other involved parties. Instead of being deleted, the encrypted sensitive data may be stored in a background application inaccessible to the user of the user device (e.g., a daemon). The daemon may be associated with the application and/or another entity. As each data exchange (e.g., the reception of sensitive data) occurs in offline mode, the application may cause validation data to be stored in the daemon, providing a count of data exchanges, a session identifier (ID) indicating the offline session, and other information. The validation data may be encrypted with a public portion of a public-private key associated with the other entity. Thus, the validation data may be inaccessible to the user of the user device.

At some time later, the user device may reconnect to a network. Then, the application may attempt to exit the offline session. To do so, the application may request the validation data and/or the encrypted sensitive data from the daemon. The application may then transmit the validation data and the encrypted sensitive data to a first entity. The first entity may then store the encrypted sensitive data and transmit the validation data to the other entity. The other entity may then decrypt the validation data and generate a digital signature in the form of a validation token indicating that the validation data is authentic (e.g., from the other entity). Using the validation data, the other entity may then transmit the validation token along with the data associated to the offline session which may be a list of transaction(s) received during this period (e.g., some or all of the validation data) to the first entity. Upon receiving the validation token and/or the validation data, the first entity may verify the integrity of the encrypted sensitive data. For example, the first entity may verify that the number of data exchanges indicated in the validation data and/or the validation token, the number of data exchanges represented in the encrypted sensitive data. Upon verifying the integrity of the encrypted sensitive data, the first entity may transmit the validation token to the user device via the application. The application may then exit the offline session after receiving the token.

Because the other entity verifies the validation data and provides the validation token and some or all of the validation data, the first entity may be sure that the validation data itself is not tampered with and/or originate from some other party (e.g., a bad actor). Then, because the first entity has a record of the data exchanges that should be represented in the encrypted sensitive data, the first entity can verify that it received an accurate record of the data exchanges performed by the user device during the offline session. The application may not exit the offline session until receiving the validation token, so there may be an added disincentive to tampering with the sensitive data and/or the validation data. Therefore, all parties involved in the exchange of sensitive data may be sure that the encrypted sensitive data is secure and accurate, and the user of the user device may continue to perform operations, even when disconnected.

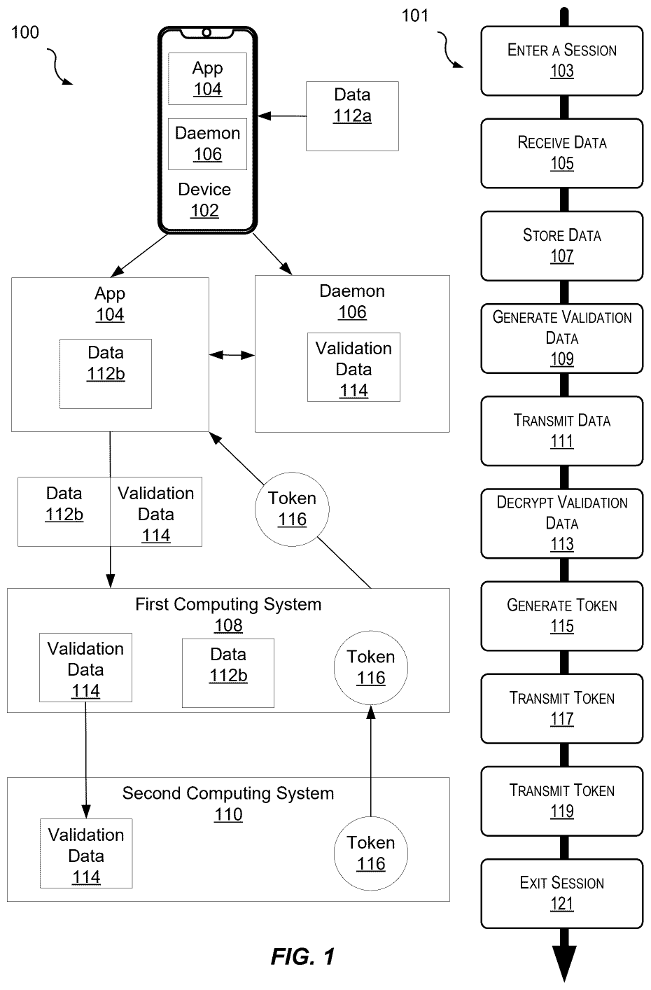

FIG. 1 illustrates a system 100 and a process 101 for validating data exchanges using a validation token 116, according to certain embodiments. The system 100 may include a user device 102 with an application 104 and a daemon 106. The system 100 may also include a first computing system 108 and a second computing system 110. The user device 102 may be a mobile phone, smart phone, tablet, laptop, computer, or any other suitable device. The user device 102 may include one or more processors, computer memory, and other components (e.g., networking and communications components). The user device 102 may also include components to receive sensitive data such as a magnetic strip reader, components to read optical codes (e.g., a bar code, a QR code, etc.), near-field communications (NFC) components, and other such components.

The first computing system 108 may be associated with an entity that processes sensitive data in order to complete a data exchange. For example, the data exchange may be a purchase or other transaction. The first computing system 108 may then be associated with a payment services processor that processes card holder data or other financial data to complete the transaction. The first computing system 108 may include one or more physical and/or virtual computers having one or more processors, computer memories, etc. such that the first computing system may perform various tasks.

The second computing system 110 may be associated with an entity further associated with the daemon 106 and/or the user device 102. For example, the entity may be a developer and/or manufacturer of the user device 102 and the daemon 106. As such some operations performed by the daemon 106 may be solely between the user device 102 (and/or the daemon 106) and the second computing system 110. Some files stored on the user device 102 may only be accessible by the second computing system 110 (or associated entity). The daemon 106, for example, may be used to store data on the user device 102 in such a way that the data is inaccessible to a user of the user device 102. Instead, the data in the daemon 106 may only be accessed by certain processes running on the user device 102 (e.g., background processes associated with an operating system, etc.).

The process 101 may be performed by some or all of the components of the system 100. In the following example, reference may be made to financial transactions. These references should be understood to be exemplary only. While sensitive data may include financial data (e.g., card holder data), sensitive data may be any data that a party desires to be kept secret. Other examples may include health data, classified data, educational data, etc.

At 103, the user device 102 and/or the application 104 may enter an offline session. The application 104 may enter the offline session in response to determining that the user device 102 is not connected to a network. For example, the user device 102 may be performing operations as normal, receiving sensitive data and transmitting the sensitive data to other entities. Then, the network connection may be lost and the application 104 enters into the offline session. Additionally or alternatively, the user device 102 may receive a user input that causes the application 104 to enter the offline session. One of ordinary skill in the art would recognize may different possibilities.

The offline session may permit the user device 102 to receive sensitive data for a predetermined amount of time. The only way to exit the offline session may be to receive a token (e.g., the token 116). If the user device 102 does not receive the token within the predetermined time period, the user device 102 (and/or application 104) may no longer receive sensitive data.

At 105, the user device 102 may receive sensitive data 112a while in an offline session. The sensitive data 112a may be cardholder data used in a transaction, health data being transferred, classified data, etc. In any event, the reception of the sensitive data 112a may be considered a data exchange, where one party is giving the sensitive data 112a to another party (i.e., the user of the user device 102). The application 104 may encrypt the sensitive data 112a to generate encrypted data 112b using a symmetrical key, a non-symmetrical key pair, some combination of the two (e.g., hybrid public key cryptography (HPKE)), or any other suitable encryption method. In some embodiments, application 104 may delete the sensitive data 112a from the user device 102 such that no plaintext version of the sensitive data 112a is stored by the user device 102.

At 107, the application 104 may store the encrypted data 112b. In some embodiments, the encrypted data 112b may be stored by a file managed by and/or via the application 104. Additionally or alternatively, the encrypted data 112b may be stored in a background application or file to which the application 104 may only write. In other words, once the application 104 stores the encrypted data 112b to the background application, the application 104 may no longer access the encrypted data 112b. Additionally or alternatively, the application 104 may cause the encrypted data 112b to be stored in the daemon 106.

At 109, the application 104 may cause validation data 114 to be generated in the daemon 106. The validation data 114 may be encrypted via symmetrical key, asymmetrical key pair, etc. The validation data 114 may only be decrypted by the second computing system 110. The validation data 114 may include a device ID (identifying the user device 102) and a session ID identifying the offline session (e.g., a time stamp, unique identifier, etc.). The validation data 114 may also include a data exchange count corresponding to each data exchange the user device 102 and/or the application 104 performs within the offline session. For example, as shown in FIG. 1, when the user device 102 receives the sensitive data 112a, one data exchange may have occurred. Thus, the validation data 114 may include a data exchange count of one. If another data exchange occurs, the data exchange count may be updated (e.g., count=2). For each data exchange in the data exchange count, the validation data 114 may include a data exchange identifier. The validation data 114 may include a record of the specific data exchanges performed by the application during the offline session. In some embodiments, the validation data 114 may also include a hash of at least a portion of the sensitive data 112a. For example, sensitive data 112a may include cardholder data. The cardholder data may include a personal identification number (PIN), primary account number (PAN), and other sensitive information. The application 104 may generate a cryptographic hash of the PIN, the PAN, and or other information and include the hash in the validation data 114.

At some subsequent point, the user device 102 and/or the application 104 may determine that the user device 102 is now connected to a network. Then, in order to exit the offline session, at 111, the application 104 may transmit the encrypted data 112b and/or the validation data 114 to the first computing system 108 as a data blob. In some embodiments, the application 104 may transmit the encrypted data 112b to the first computing system 108, and the daemon 106 may transmit the validation data 114 to the second computing system 110 (and/or the first computing system 1008). The first computing system 108 may be associated with a data processor, responsible for processing sensitive data to complete data exchanges. Using the example from above, where the sensitive data 112a includes cardholder data, the first computing system 108 may be associated with a PSP. The first computing system 108 may then decrypt the encrypted data 112b in order to complete a transaction performed by the user device 102. \The first computing system 108 may access a key from the second computing system 110 to decrypt the encrypted data 112b. In order to maintain the integrity of the encrypted data 112b, the first computing system 108 may not be able to decrypt the validation data 114. Thus, the first computing system 108 may transmit just the validation data 114 to the second computing system 110. Because the encrypted data 112b is not transmitted to the second computing system 110, a risk of exposure of the encrypted data 112b may be reduced.

At 113, the second computing system 110 may decrypt the validation data 114. As discussed above, the second computing system 110 (or an entity associated therewith), may be associated with the user device 102 and/or the application 104. The second computing system 110 may therefore be the only party able to decrypt the validation data 114. The user of the user device 102 may not be able to access (let alone decrypt) the validation data 114 as the validation data 114 is stored in the daemon 106. Therefore, the second computing system 110 may trust the validation data 114 as being authentic.

At 115, the second computing system 110 may generate a token 116. The token 116 may be a response token including the validation data 114, a digital signature, and/or a certificate. The digital signature and/or certificate may indicate that the validation data 114 is valid (e.g., originating from the user device 102 and decrypted by the second computing system 110). In some embodiments, the token 116 (or portions thereof) may be re-encrypted by the second computing system 110 using a cryptographic method that is shared with the first computing system 108. Then, the first computing system 108 and the second computing system 110 may be the only entities that can decrypt the token 116, further ensuring the integrity of the encrypted data 112b. In some embodiments, the token 116 may not include the validation data 116.

At 117, the second computing system 110 may transmit the token 116 and/or some or all of the validation data 114 the first computing system 108. The first computing system 108 may then access the information validation data 114 received from the second computing system 110 and/or included in the token 116 to verify that the encrypted data 112b has not been tampered with. For example, during the offline session, the user device 102 may have performed 10 transactions, including 9 purchases and 1 return. The validation data 114 may therefore include a data exchange count of 10 and/or data exchange IDs corresponding to each of the 10 data exchanges. The user of the user device 102 may somehow access the encrypted data 112b while stored on the user device 102 and delete the return. When the first computing system 108 receives the response (e.g., the validation token 118 and/or the validation data 11) from the second computing system 110, decrypts the encrypted data 112b, the first computing system 108 may determine that 9 data exchanges (and related sensitive data) are included. The validation data 114 and/or the token 116, however, may indicate that the user device 102 performed 10 data exchanges. Thus, the first computing system 108 may determine that the encrypted data 112b is not an accurate reflection of all the data exchanges performed by the user device 102. If by contrast, the data exchange count matches the number of data exchanges represented in the encrypted data 112b, the first computing system 108 may determine that the encrypted data 112b is an accurate reflection.

At 119, the first computing system 108 may transmit some or all of the token 116 to the user device 102. The token 116 may be received via the application 104, the daemon 106, and/or some other application. In any case, the token 116 may be verified by the daemon 106 (e.g., by checking the digital signature) as originating from the second computing system 110. Then, at 121, the daemon 106 may cause the application 104 to exit the offline session and resume operations as normal.

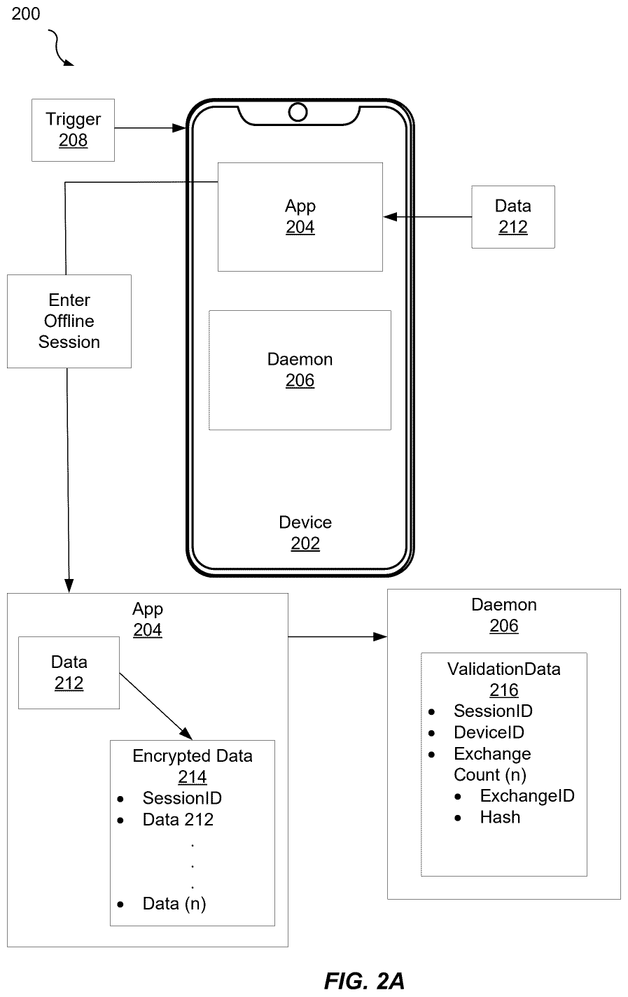

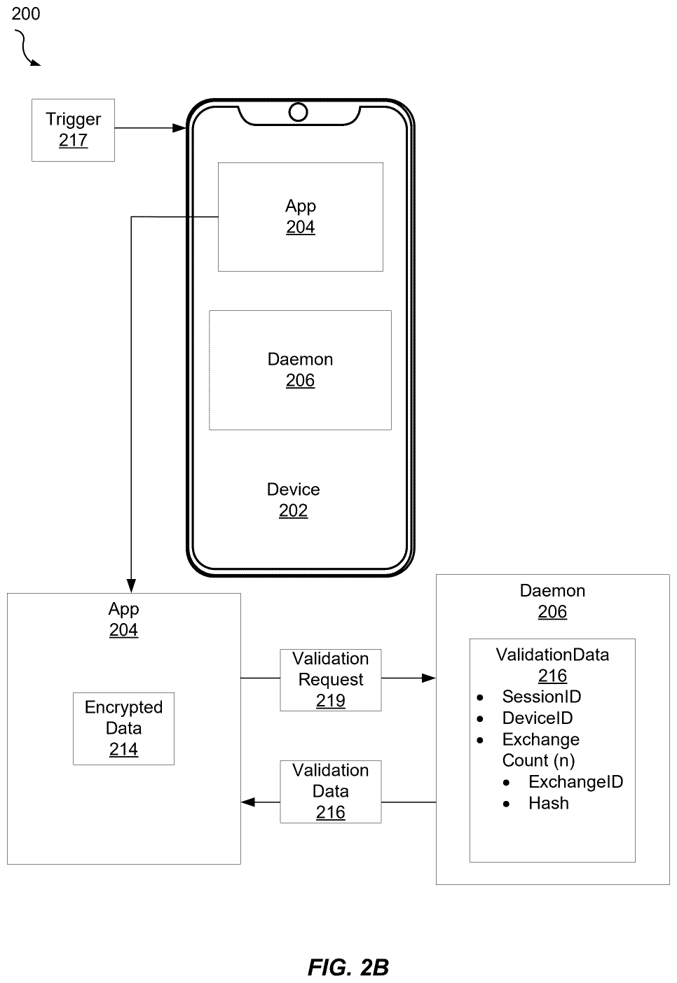

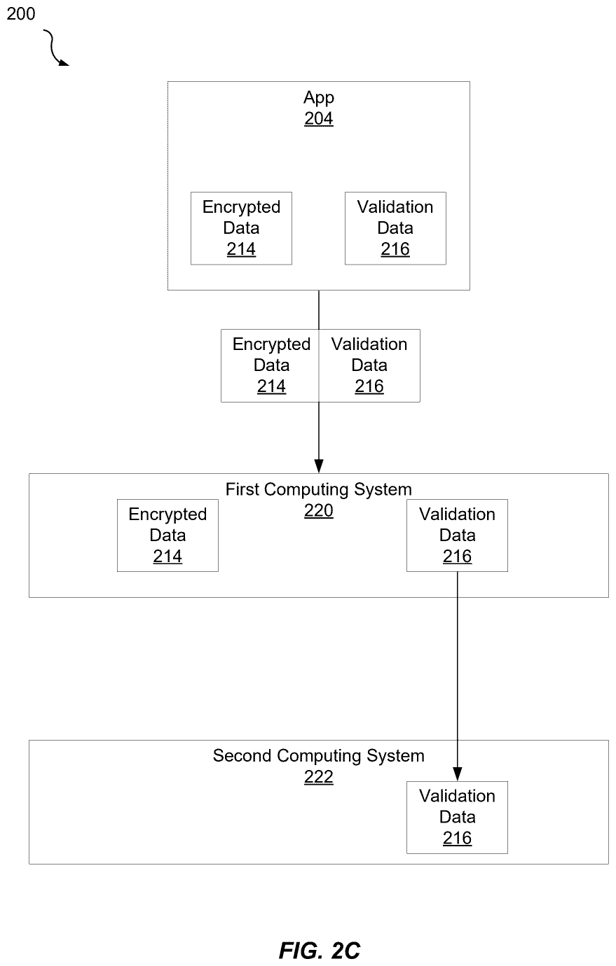

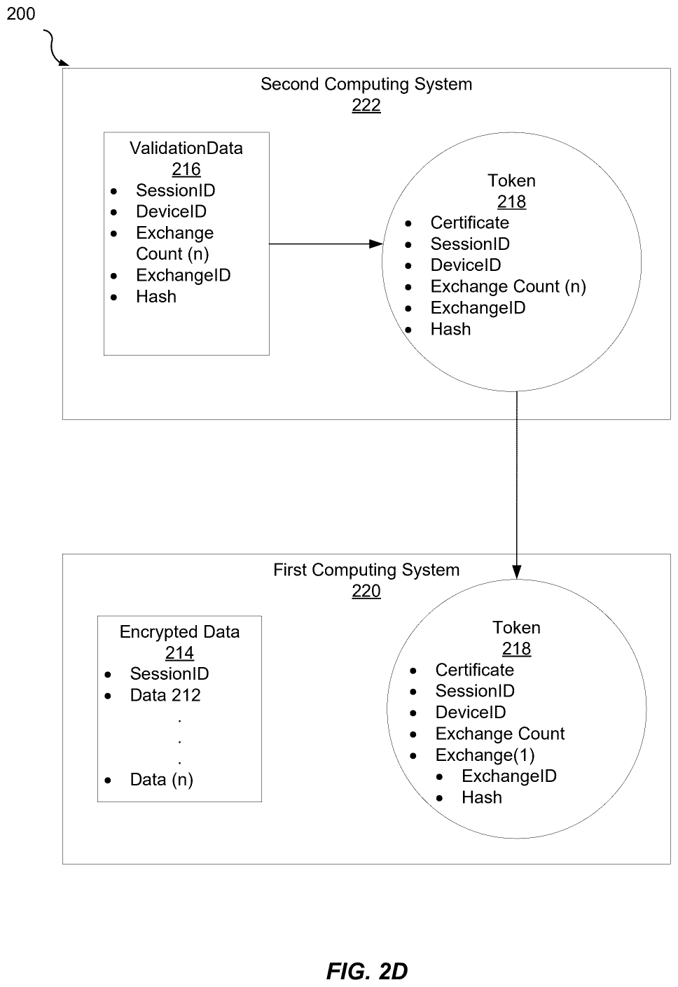

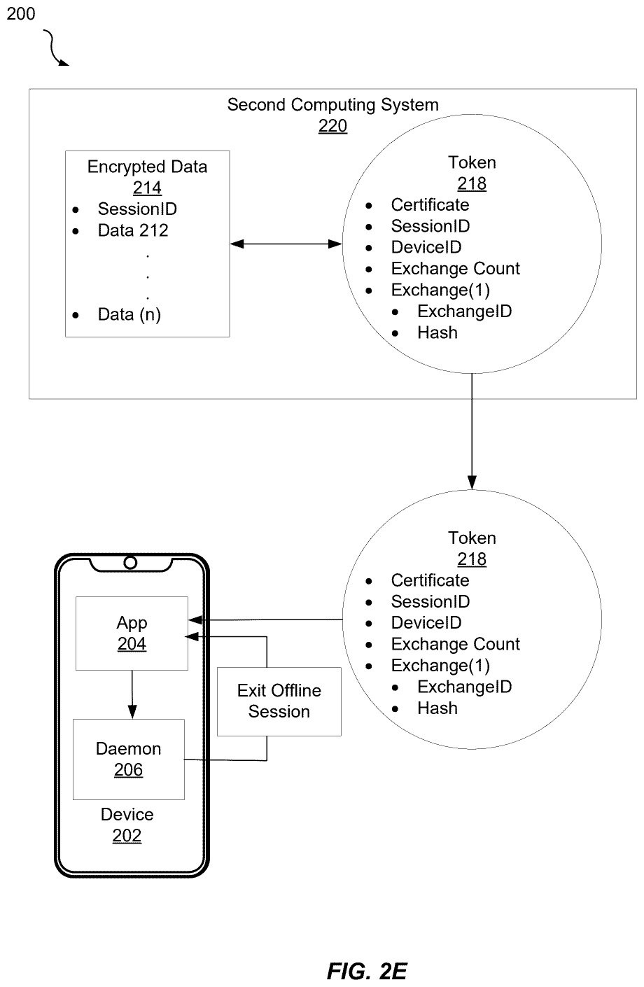

FIG. 2A-2E illustrate a system 200 for validating data exchanges while not connected to a network, according to certain embodiments. The system 200 may include some or all of the components described in relation to FIG. 1 and include similar components and functionalities. As shown in FIG. 2A, the system 200 may include a user device 202 with an application 204 and a daemon 206. The user device 202 may be similar to the user device 102 in FIG. 1, and be a be a mobile phone, smart phone, tablet, laptop, computer, or any other suitable device. The user device 202 may include one or more processors, computer memory, and other components (e.g., networking and communications components). The user device 202 may also include components to receive sensitive data such as a magnetic strip reader, components to read optical codes (e.g., a bar code, a QR code, etc.), near-field communications (NFC) components, and other such components.

The application 204 may be configured to receive sensitive data as part of a data exchange. For example, the application 204 may be part of a point of sale system and receive cardholder data as part of a transaction. The application 204 may then encrypt and transmit the cardholder data to a PSP in order to process payment and complete the transaction. In a normal mode, the application 204 may delete the plaintext cardholder data and/or the encrypted cardholder data after transmitting the cardholder data to the PSP.

The application 204 may be associated with an entity that provides services to the user device 202 in order to enable secure handling and/or processing of sensitive data. As such, the application 204 may include one or more processes that operated in the background, invisible to a user of the user device 202. The application 204 may also cause sensitive data, cryptographic keys, and other such data in one or more files that are inaccessible to the user. The application 204 may transfer the sensitive data directly to different entities in order to securely process the sensitive data via the background processes.

The daemon 206 may be a background application running on the user device 202. The daemon 206 may not be directly observable or accessible by a user of the user device 202. Thus, information stored within the daemon 206 may be secure and only accessible by the application 204 and/or other applications (e.g., an operating system) running on the user device 202. The daemon 206 may be associated with the application 204 or may be an independent application. Some or all of the data stored by or in the daemon 206 may persist on the user device 202 independently of the application 204. This way, if the application 204 were uninstalled and reinstalled on the user device 202, the data stored in the daemon 206 may not be affected. If the application 204 was uninstalled during an offline session, a reinstalled version of the application 204 may still be in the offline session, further reducing the possibility of tampering with the data within the daemon 206.

The user device 202 may receive or otherwise determine a trigger 208. The trigger 208 may be a network notification from a component of the user device (e.g., the operating system) indicating that a network connection has been lost or is unavailable. Additionally or alternatively, the trigger 208 may be a user input. In response to the trigger 208, the application 204 (and/or the user device 202) may enter an offline session. Entering the online session may cause the application 204 and/or the user device 202 to generate the daemon 206. In other embodiments, the daemon 206 may already be running on the user device 202.

The offline session may permit the user device 202 and/or the application 204 to receive sensitive data for a predetermined time period in order to enable data exchanges while not connected to a network. The predetermined time period may be 12 hours, 24 hours, 2 days, etc. If the predetermined time period expires, the application 204 may not permit any sensitive data to be received (i.e., can no longer perform data exchanges). Exiting the online session may only be done by receiving a validation token. During the offline session, the user device 202 and/or the application 204 may receive sensitive data 212 (e.g., cardholder data). The application 204 may then encrypt the sensitive data 212 to create encrypted data 214. The encrypted data 214 may include a session ID indicating the particular offline session during which the sensitive data 214 was received. The encrypted data 214 may also include a device ID, identifying the user device 202.

Although FIG. 2A only shows the application 204 receiving the sensitive data 212 (representing one data exchange), it should be understood that any number of data exchanges may be performed in the offline session (within the predetermined time period). Accordingly, the encrypted data 214 may include any number of blocks of sensitive data, each corresponding to a particular data exchange. Each block of sensitive data may also include a data exchange ID, indicating a particular data exchange associated with the block of sensitive data.

The daemon 206 may receive some or all of the sensitive data 212 and/or the encrypted data 214. In some embodiments, the application 204 may push some or all of the sensitive data 212 and/or the encrypted data 214 to the daemon 206. In other embodiments, the daemon 206 may pull some or all of the sensitive data 212 and/or the encrypted data 214 from the application 204. The daemon 206 may use the received data to generate validation data 216. The validation data 216 may include the session ID and the device ID. The validation data 216 may also include an data exchange count, indicating the number of data exchanges performed by the user device 202 and/or the application 204 during the offline session. As shown in FIG. 2A, the encrypted data 214 may include data 212-data(n), representing n data exchanges. The data exchange count included in the validation data 216 therefore has a count of n. In some embodiments, the validation data 216 may also include an exchange ID for each of the data exchanges performed by the user device 202 and/or application 204. For each exchange ID, the validation data 216 may also include a hash of at least some of the sensitive data (e.g., the sensitive data 212). For example, the sensitive data 212 may include a PIN and/or a PAN used in a data exchange. The validation data 216 may then include a hash of the PIN and/or PAN. The hash of the PIN and/or PAN may be used to verify that the data exchanges represented in the encrypted data 412 corresponds to the validation data 216. The validation data 216 may be encrypted with a symmetrical key and/or an asymmetrical key pair. An entity associated with the user device 202 and/or the daemon 206 may be the only other entity able to decrypt the validation data 216.

In FIG. 2B, the user device 202 may receive a second trigger 217. The second trigger 217 may indicate that a network connection has been restored or is otherwise available. The second trigger 217 may be received from the operating system of the user device 202, some other component of the user device 202, a user input, or any other suitable method. The user device 202 and/or the application 204 may exit the offline session, as the application 204 may now transmit sensitive data to the other parties to complete data exchanges. To exit the offline session, the application 204 may transmit a validation request 219 to the daemon 206. The daemon 206 may then transmit the validation data 216 to the application 204 and/or the second computing system 222. Because the validation data 216 may be encrypted such that only another entity may decrypt it, the user of the user device 202 may not access the validation data 216. Thus, the validation data 216 may remain secure even when transmitted from the daemon 206.

In FIG. 2C, the application 204 may transmit the encrypted data 214 and/or the validation data 216 to a first computing system 220. In some embodiments, the application 204 may transmit the encrypted data 214 to the first computing system 220 and the daemon 206 may transmit the validation data 216 to the second computing system 222. The first computing system 220 may be associated with an entity involved in processing sensitive data to complete a data exchange (e.g., a PSP). However, because the validation data 216 may be encrypted using an encryption method shared only between the daemon 206 and another entity (here, associated with a second computing system 222), the first computing system 220 may be unable to access the validation data 216. In other words, the first computing system 220 may not be able to confirm the integrity of the encrypted data 214 as received from the application 204. Therefore, the first computing system 220 may transmit the validation data 216 to the second computing system 222.

In FIG. 2D, the second computing system 222 may decrypt the validation data 216. The second computing system 222 may verify some or all of the validation data 216. For example, the first computing system 220 may have included other information about the user device 202 when transmitting the validation data 216 (e.g., a MAC ID, IP address, etc.). The second computing system 222 may then determine that the other information corresponds to the device ID included in the validation data 216.

The second computing system 222 may generate a validation token 218. The validation token 218 may include some or all of the validation data 216, such as the session ID, the device ID, the data exchange count, exchange ID(s), and other such information. Although the validation token 218 is shown to include some or all of the validation data 216, in some embodiments, the validation data 216 may be transmitted separately from the validation token 218. The second computing system 222 may digitally sign the validation token 218 and include a certificate or certificate identifier that can be used to verify the signature. The signature and/or certificate/certificate identifier may indicate that the second computing system 222 has verified some or all of the validation data 216 and/or that the validation token 218 was generated by the second computing system 222. Then, the second computing system 222 may transmit the validation token 218 to the first computing system 220.

In FIG. 2E, the first computing system 220 may use some or all of the validation data 216 to verify some or all of the data included in the encrypted data 214. The first computing system 220 may utilize the certificate to verify that the validation data 216 was received from the second computing system 222. The first computing system 220 may also verify that the validation data 216 corresponds to the encrypted data 214 (e.g., by verifying that the session ID and or the device ID included in the validation token 218 matches those indicated in the encrypted data 214). The first computing system 220 may compare the data exchange count included in the validation data 218 to the data exchanges represented in the encrypted data 214. As shown in FIG. 2E, the encrypted data 214 may represent n data exchanges. The data exchange count in the validation token 218 and/or the validation data 216 may also equal n. The first computing system 220 may therefore determine that the encrypted data 214 reflects an accurate representation of the data exchanges performed by the user device 202 during the offline session. In some embodiments, the first computing system 220 may determine a difference between data exchange count and the data exchanges reflected in the encrypted data 214. The first computing system 220 may then compare the difference to a predetermined threshold (e.g., 2, 3, 5, etc.). If the difference is below the predetermined threshold, the first computing system 220 may transmit the validation token 218 to the user device 202. For example, the data exchange count may equal 10, indicating that the user device 202 performed 10 data exchanges in the offline session. The encrypted data 214, however, may represent only 9 data exchanges. The first computing system 220 may then determine that the difference of one is below the predetermined threshold and transmit the validation token 218 to the user device 202. If the difference is above the predetermined threshold, the first computing system 220 may request the encrypted data 214 again from the user device 202 and/or transmit an error message.

The user device 202 may receive the validation token 218 from the first computing system 220. In some embodiments, the validation token 218 may be forwarded to the daemon 206 by the application 204. The application 204 and/or the daemon 206 may then verify that the validation token 218 was generated by the second computing system 222 (e.g., via the certificate included in the validation token 218). The application 204 may then exit the offline session, (e.g., by a prompt from the daemon 206). The application 204 may then continue to perform data exchanges normally. The application 204 may also cause any sensitive data (either encrypted or plaintext) to be deleted from the user device 202.

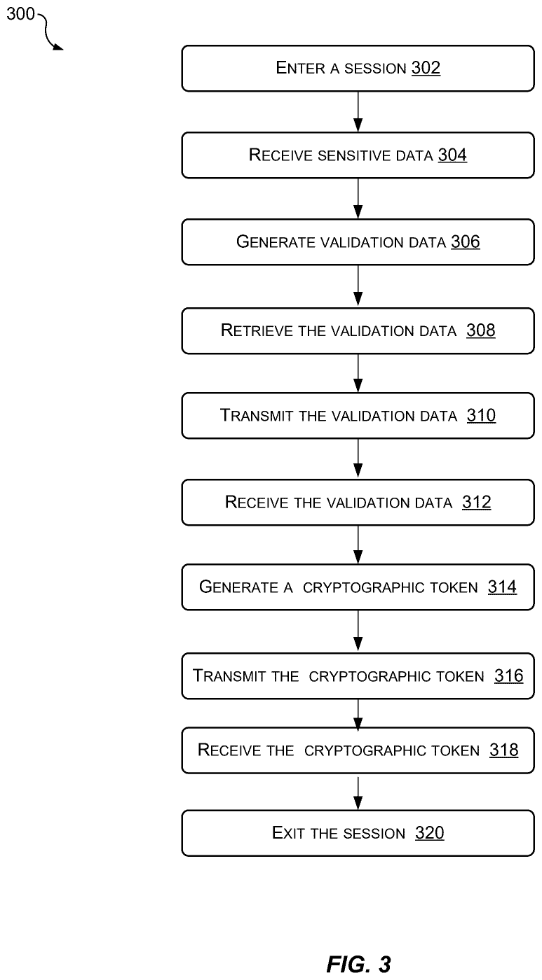

FIG. 3 illustrates a flowchart of a method 300 for validating data exchanges, according to certain embodiments. The method 300 may be performed by some or all of the systems and device described herein (e.g., the system 100 and/or the system 200). In some embodiments, the steps of the method 300 may be performed in a different order than shown and described, and/or may be combined with other steps. In some embodiments, some steps may be skipped altogether.

At step 302, the method 300 may include entering, by an application running on a user device, an offline processing session. The user device may be similar to the user device 102 in FIG. 1, and be a mobile phone, smart phone, tablet, laptop, computer, or any other suitable device. The user device may also include components to receive sensitive data such as a magnetic strip reader, components to read optical codes (e.g., a bar code, a QR code, etc.), near-field communications (NFC) components, and other such components. The application may be similar to the application 204 in FIG. 2A. The application may be configured to receive sensitive data as part of a data exchange

At step 304, the method 300 may include receiving, by the application running on the user device, sensitive data associated with one 0 or more data exchanges. For example, the application may be part of a point of sale system and receive cardholder data as part of a transaction (i.e., a data exchange). The application may then encrypt the sensitive data (e.g., the cardholder data) and store the encrypted data. The application may store the encrypted data such that it may not be accessed by a user of the user device, or may store the encrypted data in an accessible file.

At step 306, the method 300 may include generating, by a background application running on the user device, validation data comprising an exchange count, a session identifier, a device identifier. The background application may be associated with the application and/or may be associated with a manufacturer of the user device. The background application may be similar to the daemon 206 in FIG. 2A. The daemon may not be directly observable or accessible by a user of the user device 202. Thus, information stored within the daemon may be secure and only accessible by the application and/or other applications (e.g., an operating system) running on the user device. The daemon may be associated with the application or may be an independent application. Some or all of the data stored by or in the daemon may persist on the user device independently of the application. This way, if the application were uninstalled and reinstalled on the user device, the data stored in the daemon may not be affected. If the application were uninstalled during an offline session, a reinstalled version of the application may still be in the offline session, further reducing the possibility of tampering with the data within the daemon.

The validation data may include a session ID (associated with the offline processing session) and a device ID (associated with the user device). The validation data may also include an exchange count, indicating the number of data exchanges performed by the user device and/or the application during the offline processing session. In some embodiments, the validation data may also include an exchange ID for each of the data exchanges performed by the user device and/or application. For each exchange ID, the validation data may also include a hash of at least some of the sensitive data. For example, the sensitive data may include a PIN and/or a PAN used in a data exchange. The validation data may then include a hash of the PIN and/or PAN. The validation data may be encrypted with a symmetrical key and/or an asymmetrical key pair. An entity associated with the user device and/or the application may be the only other entity able to decrypt the validation data.

At step 308, the method 300 may include retrieving, by the application running on the user device, the validation data from the background application. The application may transmit a validation request from the background application in response to a trigger (e.g., the second trigger 217 in FIG. 2). The background application may transmit the validation data in an encrypted format.

At step 310, the method 300 may include transmitting, by the application running on the user device, the validation data and the sensitive data to a first computing system. The first computing system may be an entity that processes sensitive data to complete data exchanges. For example, the first computing system may be associated with a PSP that processes cardholder data to complete transactions.

At step 312, the method 300 may include receiving, by a second computing system, the validation data from the first computing system. The second computing system may be associated with the application and/or the background application. The second computing system may therefore decrypt and access the validation data. For example, the first computing system may have included other information about the user device when transmitting the validation data (e.g., a MAC ID, IP address, etc.). The second computing system may then determine that the other information corresponds to the device ID included in the validation data.

At step 314, the method 300 may include generating, by the second computing system, the response token comprising the exchange count, the session ID, and the device ID. The response token may be similar to the validation token 218 in FIG. 2D. The response token may include validation data, or the response token may be separate from the response token. The response token may include some or all of the validation data, such as the session ID, the device ID, the data exchange count, exchange ID(s), and other such information. The second computing system may digitally sign the response token and/or the validation data and include a certificate. The certificate may indicate that the second computing system has verified some or all of the validation data and/or that the response token was generated by the second computing system.

At step 316, the method 300 may include transmitting, by the second computing system, the response token-to the first computing system. The first computing system may utilize the response token and/or the validation data to verify some or all of the data included in the encrypted data. The first computing system may utilize the certificate to verify that the response token and/or validation data was generated by the second computing system. The first computing system may also verify that the response token and/or validation data to the encrypted data (e.g., by verifying that the session ID and or the device ID included in the response token and/or validation data matches those indicated in the encrypted data). The first computing system may compare the data exchange count included in the validation data to the data exchanges represented in the encrypted data.

At step 318, the method 300 may include receiving, by the background application running on the user device, the response token from the first computing system. In some embodiments, the token may be forwarded to the background application by the application. The application and/or the background application may then verify that the response token was generated by the second computing system (e.g., via the certificate and/or a certificate ID included in the token).

At step 320, the method 300 may include causing, by causing, by the background application running on the user device, the application to exit the offline processing session. The application may then continue to perform data exchanges normally. The application may also cause any sensitive data (either encrypted or plaintext) to be deleted from the user device.

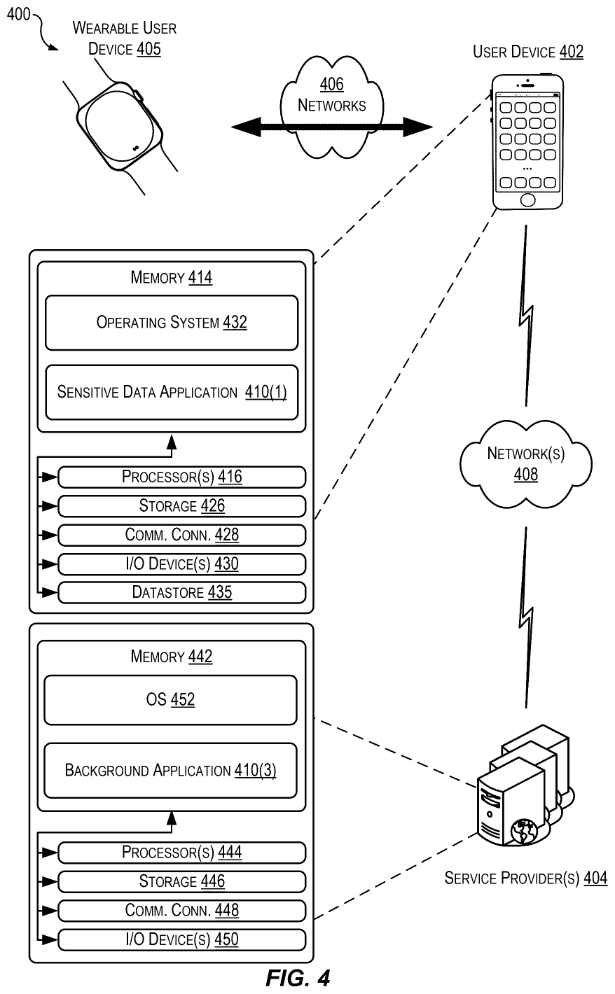

FIG. 4 illustrates an example architecture or environment 400 configured to implement techniques relating to validating data exchanges, according to certain embodiments. In some examples, the example architecture 400 may further be configured to enable a user device 402 (e.g., the user device 102), the service provider computers 404 (e.g., the service provider 404), and a wearable electronic device 405 (e.g., an example accessory deice) to share information. In some examples, the devices may be connected via one or more networks 408 and/or 406 (e.g., via Bluetooth, WiFi, the Internet, or the like). In the architecture 400, one or more users may utilize the user device 402 to manage, control, or otherwise utilize the wearable electronic device 405, via the one or more networks 406. Additionally, in some examples, the wearable electronic device 405, the service provider computers 404, and the user device 402 may be configured or otherwise built as a single device. For example, the wearable electronic device 405 and/or the user device 402 may be configured to implement the examples described herein as a single computing unit, exercising the examples described above and below without the need for the other devices described.

In some examples, the networks 406, 408 may include any one or a combination of many different types of networks, such as cable networks, the Internet, wireless networks, cellular networks, satellite networks, other private and/or public networks, or any combination thereof. While the illustrated example represents the user device 402 accessing the service provider computers 404 via the networks 408, the described techniques may equally apply in instances where the user device 402 interacts with the service provider computers 404 over a landline phone, via a kiosk, or in any other manner. It is also noted that the described techniques may apply in other client/server arrangements (e.g., set-top boxes, etc.), as well as in non-client/server arrangements (e.g., locally stored applications, peer to peer configurations, etc.).

The user device 402 may be any type of computing device such as, but not limited to, a mobile phone, a smartphone, a personal digital assistant (PDA), a laptop computer, a desktop computer, a thin-client device, a tablet computer, a wearable device, or the like. In some examples, the user device 402 may be in communication with the service provider computers 404 via the networks 408, 406, or via other network connections.

In one illustrative configuration, the user device 402 may include at least one memory 414 and one or more processing units (or processor(s)) 416. The processor(s) 416 may be implemented as appropriate in hardware, computer-executable instructions, firmware, or combinations thereof. Computer-executable instruction or firmware implementations of the processor(s) 416 may include computer-executable or machine-executable instructions written in any suitable programming language to perform the various functions described. The user device 402 may also include geo-location devices (e.g., a global positioning system (GPS) device or the like) for providing and/or recording geographic location information associated with the user device 402.

The memory 414 may store program instructions that are loadable and executable on the processor(s) 416, as well as data generated during the execution of these programs. Depending on the configuration and type of the user device 402, the memory 414 may be volatile (such as random access memory (RAM)) and/or non-volatile (such as read-only memory (ROM), flash memory, etc.). The user device 402 may also include additional removable storage and/or non-removable storage 426 including, but not limited to, magnetic storage, optical disks, and/or tape storage. The disk drives and their associated non-transitory computer-readable media may provide non-volatile storage of computer-readable instructions, data structures, program modules, and other data for the computing devices. In some implementations, the memory 414 may include multiple different types of memory, such as static random access memory (SRAM), dynamic random access memory (DRAM), or ROM. While the volatile memory described herein may be referred to as RAM, any volatile memory that would not maintain data stored therein once unplugged from a host and/or power would be appropriate.

The memory 414 and the additional storage 426, both removable and non-removable, are all examples of non-transitory computer-readable storage media. For example, non-transitory computer readable storage media may include volatile or non-volatile, removable or non-removable media implemented in any process or technology for storage of information such as computer-readable instructions, data structures, program modules, or other data. The memory 414 and the additional storage 426 are both examples of non-transitory computer storage media. Additional types of computer storage media that may be present in the user device 44 may include, but are not limited to, phase-change RAM (PRAM), SRAM, DRAM, RAM, ROM, Electrically Erasable Programmable Read-Only Memory (EEPROM), flash memory or other memory technology, compact disc read-only memory (CD-ROM), digital video disc (DVD) or other optical storage, magnetic cassettes, magnetic tape, magnetic disk storage or other magnetic storage devices, or any other medium that can be used to store the desired information and that can be accessed by the user device 402. Combinations of any of the above should also be included within the scope of non-transitory computer-readable storage media. Alternatively, computer-readable communication media may include computer-readable instructions, program modules, or other data transmitted within a data signal, such as a carrier wave, or other transmission. However, as used herein, computer-readable storage media does not include computer-readable communication media.

The user device 402 may also contain communications connection(s) 428 that allow the user device 402 to communicate with a data store, another computing device or server, user terminals, and/or other devices via the networks 408, 406. The user device 402 may also include I/O device(s) 430, such as a keyboard, a mouse, a pen, a voice input device, a touch input device, a display, an operating system 432 and/or one or more application programs or services for implementing the features disclosed herein including a sensitive data application 410(1). In some examples, the sensitive data application 410(1) may be configured to implement the features described herein such as those described with reference to the flowcharts. User device 402 may also include a datastore 435. The datastore 435 may be a separate memory partition within the memory 414 or may be an individual hardware component of the user device 402. The datastore 435 may be configured as a sensitive data datastore, and may not be accessible to a user of the user device 402.

The service provider computers 404 may also be any type of computing device such as, but not limited to, a mobile phone, a smartphone, a PDA, a laptop computer, a desktop computer, a thin-client device, a tablet computer, a wearable device, a server computer, a virtual machine instance, etc. In some examples, the service provider computers 404 may be in communication with the user device 402 and/or the wearable user device 405 via the networks 408, 406, or via other network connections. The user device 402 may communicate with the sensitive data datastore 435 via the service computers 404.

In one illustrative configuration, the service provider computers 404 may include at least one memory 442 and one or more processing units (or processor(s)) 444. The processor(s) 444 may be implemented as appropriate in hardware, computer-executable instructions, firmware, or combinations thereof. Computer-executable instruction or firmware implementations of the processor(s) 444 may include computer-executable or machine-executable instructions written in any suitable programming language to perform the various functions described.

The memory 442 may store program instructions that are loadable and executable on the processor(s) 444, as well as data generated during the execution of these programs. Depending on the configuration and type of service provider computer 404, the memory 442 may be volatile (such as RAM) and/or non-volatile (such as ROM, flash memory, etc.). The service provider computer 404 may also include additional removable storage and/or non-removable storage 446 including, but not limited to, magnetic storage, optical disks, and/or tape storage. The disk drives and their associated non-transitory computer-readable media may provide non-volatile storage of computer-readable instructions, data structures, program modules, and other data for the computing devices. In some implementations, the memory 442 may include multiple different types of memory, such as SRAM, DRAM, or ROM. While the volatile memory described herein may be referred to as RAM, any volatile memory that would not maintain data stored therein once unplugged from a host and/or power would be appropriate. The memory 442 and the additional storage 446, both removable and non-removable, are both additional examples of non-transitory computer-readable storage media.

The service provider computer 404 may also contain communications connection(s) 448 that allow the service provider computer 404 to communicate with a data store, another computing device or server, user terminals and/or other devices via the networks 408, 406. The service provider computer 404 may also include I/O device(s) 450, such as a keyboard, a mouse, a pen, a voice input device, a touch input device, a display, speakers, a printer, etc. The memory 442 may include an operating system 452 and/or one or more application programs or services for implementing the features disclosed herein including the background application 410(3) (e.g., the daemon 206 in FIG. 2A). Thus, in some examples, the background application 410(3) may be configured to implement the some or all of the features described herein such as those described with reference to the flowcharts.

The various examples further can be implemented in a wide variety of operating environments, which in some cases can include one or more user computers, computing devices or processing devices which can be used to operate any of a number of applications. User or client devices can include any of a number of general purpose personal computers, such as desktop or laptop computers running a standard operating system, as well as cellular, wireless and handheld devices running mobile software and capable of supporting a number of networking and messaging protocols. Such a system also can include a number of workstations running any of a variety of commercially available operating systems and other known applications for purposes such as development and database management. These devices also can include other electronic devices, such as dummy terminals, thin-clients, gaming systems, and other devices capable of communicating via a network.

Most examples utilize at least one network that would be familiar to those skilled in the art for supporting communications using any of a variety of commercially available protocols, such as TCP/IP, OSI, FTP, UPnP, NFS, CIFS, and AppleTalk. The network can be, for example, a local area network, a wide-area network, a virtual private network, the Internet, an intranet, an extranet, a public switched telephone network, an infrared network, a wireless network, and any combination thereof.

In examples utilizing a network server, the network server can run any of a variety of server or mid-tier applications, including HTTP servers, FTP servers, CGI servers, data servers, Java servers, and business application servers. The server(s) may also be capable of executing programs or scripts in response to requests from user devices, such as by executing one or more applications that may be implemented as one or more scripts or programs written in any programming language, such as Java®, C, C# or C++, or any scripting language, such as Perl, Python or TCL, as well as combinations thereof. The server(s) may also include database servers, including without limitation those commercially available from Oracle®, Microsoft®, Sybase®, and IBM®.

The environment can include a variety of data stores and other memory and storage media as discussed above. These can reside in a variety of locations, such as on a storage medium local to (and/or resident in) one or more of the computers or remote from any or all of the computers across the network. In a particular set of examples, the information may reside in a storage-area network (SAN) familiar to those skilled in the art. Similarly, any necessary files for performing the functions attributed to the computers, servers or other network devices may be stored locally and/or remotely, as appropriate. Where a system includes computerized devices, each such device can include hardware elements that may be electrically coupled via a bus, the elements including, for example, at least one central processing unit (CPU), at least one input device (e.g., a mouse, keyboard, controller, touch screen, or keypad), and at least one output device (e.g., a display device, printer, or speaker). Such a system may also include one or more storage devices, such as disk drives, optical storage devices, and solid-state storage devices such as RAM or ROM, as well as removable media devices, memory cards, flash cards, etc.

Such devices also can include a computer-readable storage media reader, a communications device (e.g., a modem, a network card (wireless or wired), an infrared communication device, etc.), and working memory as described above. The computer-readable storage media reader can be connected with, or configured to receive, a non-transitory computer readable storage medium, representing remote, local, fixed, and/or removable storage devices as well as storage media for temporarily and/or more permanently containing, storing, transmitting, and retrieving computer-readable information. The system and various devices also typically will include a number of software applications, modules, services, or other elements located within at least one working memory device, including an operating system and application programs, such as a client application or browser. It should be appreciated that alternate examples may have numerous variations from that described above. For example, customized hardware might also be used and/or particular elements might be implemented in hardware, software (including portable software, such as applets) or both. Further, connection to other computing devices such as network input/output devices may be employed.

Non-transitory storage media and computer-readable media for containing code, or portions of code, can include any appropriate media known or used in the art, including storage media, such as, but not limited to, volatile and non-volatile, removable and non-removable media implemented in any method or technology for storage of information such as computer-readable instructions, data structures, program modules, or other data, including RAM, ROM, EEPROM, flash memory or other memory technology, CD-ROM, DVD or other optical storage, magnetic cassettes, magnetic tape, magnetic disk storage or other magnetic storage devices, or any other medium which can be used to store the desired information and which can be accessed by a system device. Based at least in part on the disclosure and teachings provided herein, a person of ordinary skill in the art will appreciate other ways and/or methods to implement the various examples.

The specification and drawings are, accordingly, to be regarded in an illustrative rather than a restrictive sense. It will, however, be evident that various modifications and changes may be made thereunto without departing from the broader spirit and scope of the disclosure as set forth in the claims.

Other variations are within the spirit of the present disclosure. Thus, while the disclosed techniques are susceptible to various modifications and alternative constructions, certain illustrated examples thereof are shown in the drawings and have been described above in detail. It should be understood, however, that there is no intention to limit the disclosure to the specific form or forms disclosed, but on the contrary, the intention is to cover all modifications, alternative constructions and equivalents falling within the spirit and scope of the disclosure, as defined in the appended claims.

The use of the terms “a” and “an” and “the” and similar referents in the context of describing the disclosed examples (especially in the context of the following claims) are to be construed to cover both the singular and the plural, unless otherwise indicated herein or clearly contradicted by context. The terms “comprising,” “having,” “including,” and “containing” are to be construed as open-ended terms (e.g., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate examples of the disclosure and does not pose a limitation on the scope of the disclosure unless otherwise claimed. No language in the specification should be construed as indicating any non-claimed element as essential to the practice of the disclosure.

Disjunctive language such as the phrase “at least one of X, Y, or Z,” unless specifically stated otherwise, is otherwise understood within the context as used in general to present that an item, term, etc., may be either X, Y, or Z, or any combination thereof (e.g., X, Y, and/or Z). Thus, such disjunctive language is not generally intended to, and should not, imply that certain examples require at least one of X, at least one of Y, or at least one of Z to each be present.

Preferred examples of this disclosure are described herein, including the best mode known to the inventors for carrying out the disclosure. Variations of those preferred examples may become apparent to those of ordinary skill in the art upon reading the foregoing description. The inventors expect skilled artisans to employ such variations as appropriate, and the inventors intend for the disclosure to be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

All references, including publications, patent applications, and patents, cited herein are hereby incorporated by reference to the same extent as if each reference were individually and specifically indicated to be incorporated by reference and were set forth in its entirety herein.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed blocks for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the U.S., collection of or access to certain health data may be governed by federal and/or state laws, such as the Health Insurance Portability and Accountability Act (HIPAA); whereas health data in other countries may be subject to other regulations and policies and should be handled accordingly. Hence, different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of advertisement delivery services or other services relating to health record management, the present technology can be configured to allow users to select to “opt in” or “opt out” of participation in the collection of personal information data during registration for services or anytime thereafter. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain financial applications, data de-identification can be used to protect a user's privacy and/or sensitive data. De-identification may be facilitated, when appropriate, by removing specific identifiers (e.g., date of birth), controlling the amount or specificity of data stored (e.g., collecting location data at a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data.

What is claimed is:

1. A method of validating data exchanges via a token, comprising:
receiving, by a first computing system, validation data from a second computing system, the validation data comprising respective data exchange identifiers, each respective data identifier associated with a respective data exchange performed by an application executed on a user device in an offline processing session;
verifying, by the first computing system, at least some of the validation data;
generating, by the first computing system, a token indicating that the validation data is authentic; and
transmitting, by the first computing system, the token to the second computing system, the token configured to be received by the application executed on the user device.

2. The method of claim 1, wherein the validation data further comprises at least one of an exchange count, a session identifier, or a device identifier associated with the user device.

3. The method of claim 1, wherein the offline processing session is initiated by a trigger.

4. The method of claim 1, wherein the token is configured to permit the application to end the offline processing session.

5. The method of claim 1, wherein the respective data exchange identifiers are further associated with a hash of at least a portion of user data in the respective data exchanges.

6. The method of claim 5, wherein the user data comprises transaction data.

7. The method of claim 1, wherein the application executed on the user device stores data associated with each of the respective data exchanges performed in the offline processing session in a background application.

8. A system, comprising:
one or more processors; and
a computer-readable memory comprising instructions that, when executed by the one or more processors, cause the system to perform operations to:
receive, by a first computing system, validation data from a second computing system, the validation data comprising respective data exchange identifiers, each of the respective data exchange identifiers associated with a respective data exchange performed by an application executed on a user device in an offline processing session;
verify, by the first computing system, at least some of the validation data;
generate, by the first computing system, a token indicating that the validation data is authentic; and
transmit, by the first computing system, the token to the second computing system, the token to the second computing system, the token configured to be received by the application executed on the user device.

9. The system of claim 8, wherein the validation data further comprises at least one of an exchange count, a session identifier, or a device identifier associated with a user device.

10. The system of claim 8, wherein the offline processing session is initiated by a trigger.

11. The system of claim 10, wherein the token is configured to permit the application to end the offline processing session.

12. The system of claim 8, wherein the respective data exchange identifiers are further associated with a hash of at least a portion of user data in the respective data exchanges.

13. The system of claim 12, wherein the user data comprises transaction data.

14. The system of claim 8, wherein the application executed on the user device stores data associated with each of the respective data exchanges performed in the offline processing session in a background application.

15. A non-transitory computer-readable medium comprising instructions that, when executed by one or more processors, cause the one or more processors to perform operations comprising:
receiving, by a first computing system, validation data from a second computing system, the validation data comprising respective data exchange identifiers, each respective data identifier associated with a respective data exchange performed by an application executed on a user device in an offline processing session;
verifying, by the first computing system, at least some of the validation data;
generating, by the first computing system, a token indicating that the validation data is authentic; and
transmitting, by the first computing system, the token to the second computing system, the token configured to be received by the application executed on the user device.

16. The non-transitory computer-readable medium of claim 15, wherein the validation data further comprises at least one of an exchange count, a session identifier, or a device identifier associated with a user device.

17. The non-transitory computer-readable medium of claim 15, wherein the offline processing session is initiated by a trigger.

18. The non-transitory computer-readable medium of claim 17, wherein the token is configured to permit the application to end the offline processing session.

19. The non-transitory computer-readable medium of claim 15, wherein the respective data exchange identifiers are further associated with a hash of at least a portion of user data in the respective data exchanges.

20. The non-transitory computer-readable medium of claim 19, wherein the user data comprises transaction data.
